(19) United States
(12) Patent Application Publication
(10) Pub. No.: US 2026/0128434 A1
(43) Pub. Date: May 7, 2026

(54) MULTIFUNCTIONAL TIRE AND PRODUCTION METHOD THEREFOR

(71) Applicant: Panasonic Intellectual Property Management Co., Ltd., Osaka (JP)

(72) Inventors: TADAYOSHI TAKAHASHI, Osaka (JP); TOMOHIRO UEDA, Osaka (JP)

(21) Appl. No.: 19/117,422

(22) PCT Filed: Aug. 22, 2023
(86) PCT No.: PCT/JP2023/030171

§ 371 Date: Apr. 1, 2025

(30) Foreign Application Priority Data
Oct. 11, 2022 (JP) 2022-163462

(51) Int. Cl. H01M 50/242; B60C 23/04; H01M 4/02; H01M 4/485; H01M 10/052; H01M 50/109; H01M 50/186; H01M 50/202; H01M 50/548; H01M 50/559

(52) U.S. Cl. CPC H01M 50/242; B60C 23/04; H01M 4/485; H01M 10/052; H01M 50/109; H01M 50/186; H01M 50/202; H01M 50/548; H01M 50/559; H01M 2004/027

(57) ABSTRACT

A multifunctional tire includes a tire and a device fixed to the tire. The device includes a substrate and a flat secondary battery connected to the substrate with a terminal. The secondary battery is covered by a resin. The secondary battery includes an exterior body and a positive electrode and a negative electrode disposed in the exterior body. The negative electrode contains a transition metal oxide as a negative electrode active material. The exterior body includes a positive electrode can having a bottomed cylindrical shape and a negative electrode can having a bottomed cylindrical shape. The negative electrode can faces the substrate. The secondary battery is disposed outside the substrate as viewed from a rotation center of the tire.

### TECHNICAL FIELD

The present disclosure relates to a multifunctional tire to which a device including a flat secondary battery is fixed, and a method for producing the multifunctional tire.

### BACKGROUND ART

In recent years, a device for monitoring a state (for example, air pressure) of a tire or the like is attached to the tire. Such a device includes a battery serving as a power source. Various proposals have been made on a method for attaching the battery used in such a device.

In Claim 1 of PTL 1 (Japanese Patent Application Laid-Open No. 2011 014452), “a method for attaching a flat battery used in a device including a substrate and attached to a tire, the method including disposing the flat battery inside the substrate as viewed from a rotation center of the tire” is described.

Claim 1 of PTL 2 (Unexamined Japanese Patent Publication No. 2014-160660) describes “a method for attaching a flat battery used in a device including a substrate and attached to a rotating portion, in which the flat battery is obtained by combining a positive electrode can and a negative electrode can facing each other, the substrate and the flat battery face each other and are connected via a terminal, the electrode can, facing the substrate, out of the positive electrode can and the negative electrode can is a can where a deformation amount due to expansion of the flat battery is small, and the method comprises embedding the substrate and the flat battery in a resin”.

Claim 1 of PTL 3 (International Publication No. WO 2017/155035) describes “a tire air pressure detection system disposed in a tire, the tire air pressure detection system including an air pressure detection device that detects an air pressure in the tire, and a secondary battery that supplies power to the air pressure detection device, in which the secondary battery is a lithium secondary battery including a negative electrode having a lithium alloy as an active material and a positive electrode”.

### CITATION LIST

### Patent Literature

PTL 1: Unexamined Japanese Patent Publication No. 2011-014452
PTL 2: Unexamined Japanese Patent Publication No. 2014-160660
PTL 3: International Publication No. WO 2017/155035

### SUMMARY OF THE INVENTION

At present, for automated driving, a next generation tire monitoring system (TMS) that not only detects an air pressure of a tire but also senses various types of information such as an acceleration, wear, and a temperature has been studied. In the next generation tire monitoring system (TMS), since an information amount and a communication frequency remarkably increase, a capacity of a primary battery becomes insufficient. In PTL 1, a method for attaching a battery to a substrate in a device attached to a tire has been proposed as prevention of breakage of battery internal components due to impact and vibration. In PTL 2, a method for attaching a battery to a substrate in a device attached to a rotating portion for suppression of degradation of battery characteristics generated due to a centrifugal force and generated due to an influence on misalignment of a terminal from the substrate and cracking of the substrate due to expansion of the battery has been proposed. In PTL 3, a lithium secondary battery using a lithium alloy as a negative electrode active material for a tire pressure gauge has been proposed. Since the number of sensors and the like is increased compared to the related art, an attachment position of the secondary battery is important. In addition, a characteristic change generated due to charging and discharging of the secondary battery and the like also needs to be taken into consideration.

A multifunctional tire according to the present disclosure does not require battery replacement, is suitable for monitoring a state of a tire, and has high long-term reliability.

A multifunctional tire according to the present disclosure includes a tire configured to rotate about a rotation center; and a device fixed to the tire. The device includes a substrate and a flat secondary battery connected to the substrate via a terminal. The flat secondary battery is covered by a resin. The flat secondary battery includes an exterior body, and a positive electrode and a negative electrode disposed in the exterior body. The negative electrode contains a transition metal oxide as a negative electrode active material. The exterior body includes a positive electrode can having a bottomed cylindrical shape and a negative electrode can having a bottomed cylindrical shape. The negative electrode can faces the substrate. The flat secondary battery is disposed outside the substrate as viewed from the rotation center of the tire.

A method for producing a multifunctional tire according to another aspect of the present disclosure comprises preparing a device including a substrate and a flat secondary battery, preparing a tire configured to rotate about a rotation center, and fixing the device to the tire. The flat secondary battery is connected to the substrate via a terminal, and the flat secondary battery is covered by a resin. The flat secondary battery includes an exterior body, and a positive electrode and a negative electrode disposed in the exterior body. The negative electrode contains a transition metal oxide as a negative electrode active material. The exterior body includes a positive electrode can having a bottomed cylindrical shape and a negative electrode can having a bottomed cylindrical shape. The negative electrode can faces the substrate. The fixing of the device to the tire includes fixing the device to the tire to allow the flat secondary battery to be disposed outside the substrate as viewed from the rotation center of the tire.

The present disclosure provides a multifunctional tire to which a device using a flat secondary battery is fixed, the multifunctional tire being suitable for monitoring a state of the tire and having high long-term reliability.

### BRIEF DESCRIPTION OF THE DRAWINGS

FIG. 1 is a diagram schematically illustrating a device and a tire according to a first exemplary embodiment.

FIG. 2A is a top view schematically illustrating an example of a flat secondary battery used in the device according to the first exemplary embodiment.

FIG. 2B schematically illustrates a section taken along line IIB-IIB of the flat secondary battery of FIG. 2A.

FIG. 3 schematically illustrates a configuration and a disposition of the device of the first exemplary embodiment.

### DESCRIPTION OF EMBODIMENT

Hereinafter, exemplary embodiments according to the present disclosure will be described with reference to examples, but the present disclosure is not limited to examples to be described below. Although specific numerical values and materials may be provided as examples in the description below, other numerical values and materials may be applied as long as an effect of the present disclosure can be obtained. In the following description, in a case where examples of configuration elements or examples of methods are listed, only one of the listed examples may be used, or a plurality of examples of the listed examples may be used in combination unless otherwise specified.

### Device Attached to Tire

A device according to the present exemplary embodiment is a device attached to a tire. Hereinafter, the device may be referred to as “device D”. Device (D) includes a substrate and a flat secondary battery connected to the substrate with a terminal, and the flat secondary battery is covered by a resin. The flat secondary battery includes an exterior body, and a positive electrode and a negative electrode disposed in the exterior body. The negative electrode contains a transition metal oxide as a negative electrode active material. The exterior body includes a positive electrode can having a bottomed cylindrical shape and a negative electrode can having a bottomed cylindrical shape. The negative electrode can faces the substrate. The flat secondary battery is disposed outside the substrate as viewed from a rotation center of the tire.

In a next generation tire monitoring system (TMS), since a capacity of a primary battery is insufficient, a secondary battery is required. In addition, unlike the attachment to a valve in the related art, the device attached to the tire in the next generation tire monitoring system (TMS) is disposed on an inner surface of a tread surface which comes into direct contact with the ground, an inner surface of a side wall surface of a side surface of the tire, or a wheel. Thus, an impact or vibration is applied to the device in addition to a centrifugal force. A larger physical external force than that in the related art easily causes a problem such as disconnection between a terminal of the secondary battery and the substrate. In addition, characteristic degradation generated due to breakage of configuration components inside the battery is likely to occur. Further, the device is easily influenced by heat such as a road surface temperature from the tire and friction during traveling, and is more easily influenced by a temperature change impact than that in the related art. For example, the temperature changes drastically in a range of −40° C. at a low temperature and 105° C., 125° C., and 150° C. at a high temperature. In particular, the battery is easily exposed to a high temperature generated due to a temperature rise, and the battery easily degrades. In the next generation tire monitoring system (TMS), the influence of the physical external force and the temperature such as the high temperature is larger than that in the related art.

In a secondary battery using a lithium alloy as a negative electrode active material, the negative electrode active material is pulverized by expansion and shrinkage of the negative electrode active material during charging and discharging, and a discharging capacity decreases due to desorption of the negative electrode active material from the negative electrode and a decrease in current collectability. When a device including the secondary battery using the lithium alloy as the negative electrode active material is attached to a tire, the physical external force such as the impact or vibration and the temperature change impact from the low temperature to the high temperature are applied in a combined manner in addition to the centrifugal force, while a charging and discharging cycle is repeated. As a result, the pulverization of the lithium alloy of the negative electrode active material rapidly proceeds, and the capacity of the secondary battery rapidly decreases. Thus, due to the degradation of the secondary battery, performance required for the device itself fails to be maintained for a long period of time, and it is necessary to periodically replace the secondary battery similarly to the case of the primary battery.

Device (D) uses a secondary battery including a negative electrode containing a transition metal oxide as the negative electrode active material of the present invention. Since the transition metal oxide has small expansion and shrinkage at the time of the charging and discharging cycle, the pulverization does not occur, and there is no desorption of the active material or degradation of current collectability, and thus, excellent charging and discharging cycle performance can be maintained. In addition, the device is hardly influenced by the physical external force and the temperature change impact. Thus, in the secondary battery of the present invention, it is not necessary to replace the battery, and it is possible to secure a sufficient battery capacity for a long period of time. Further, in device (D), since the secondary battery is embedded in the resin, the physical external force does not directly influence the battery, and it is possible to suppress the occurrence of defects such as disconnection between the battery terminal and the substrate and damage to an internal configuration of the battery. In addition, in device (D), the negative electrode can is disposed closer to the rotation center of the tire than the positive electrode can. The influence of the temperature rise of the tire is reduced on the negative electrode. An actual load applied to the battery greatly changes depending on a combination of an ambient temperature and a charging state, and the degradation of the battery at the time of charging is accelerated as the temperature rises. Due to the design of the battery, charging and discharging depends on the negative electrode capacity, because the negative electrode capacity is smaller than a positive electrode capacity. Thus, the transition metal oxide of the negative electrode is more easily influenced than that of the positive electrode. Thus, in a high temperature charging state, the influence of degradation generated due to a reaction between the negative electrode and an electrolyte increases. By disposing the negative electrode can of the present invention, the influence of the temperature rise of the tire can be reduced, and the degradation of the battery is suppressed. As described above, in device (D), it is possible to maintain a sufficient battery capacity even in a severe environment attached to the tire. In addition, since the negative electrode has a larger volume change during charging and discharging than the positive electrode, the negative electrode is weaker in terms of strength, and physical damage of the negative electrode is also reduced as an effect of battery disposition. Thus, device (D) has high maintenance-free reliability for a long period of time without requiring battery replacement. That is, device (D) is suitable for monitoring the state of the tire and has high reliability. A multifunctional tire includes a tire and device (D) fixed to the tire. In addition to an original function of the tire, the multifunctional tire further has an additional function such as monitoring a state of the tire from an outside.

Device (D) can be used for monitoring a pressure, a temperature, an acceleration, and the like in the tire. That is, device (D) can be used for the tire monitoring system (TMS). In addition, in accordance with the purpose, device (D) includes electronic components such as necessary sensors in accordance with information to be acquired.

In device (D), a flat secondary battery is disposed outside the substrate as viewed from the rotation center of the tire. Thus, in device (D), at least a part or all of the electronic components can be disposed inside the substrate (i.e., disposed on a surface of the substrate on which the flat secondary battery is not disposed) as viewed from the rotation center of the tire. Thus, a size and a weight of device (D) can be reduced. In a case where a device for monitoring the state of the tire is attached to the tire, it is particularly important to reduce the size and weight of the device from the viewpoint of the balance of the tire and the fuel efficiency. In addition, in the above disposition, it is possible to reduce the influence of the physical external force such as the centrifugal force, impact, and vibration from the tire on the electronic components other than the secondary battery, and thermal shock changes. Of course, at least a part or all of the electronic components may be disposed on a surface of the substrate on which the flat secondary battery is disposed. In the disposition of the present invention, the resistance of the electronic components other than the flat secondary battery under the severe environment attached to the tire can also be improved.

Device (D) is fixed to an inner surface of the tire (i.e., fixed to a surface that is not exposed to an outside air in use). For example, device (D) may be fixed to a tread portion coming into contact with the ground of the tire or a side wall portion of a side surface. A method for fixing device (D) to the tire is not limited. Device (D) may be placed in a holder in which the device can be fixed to the inner surface of the tire or fixed to the tire directly with an adhesive. Alternatively, Device (D) may be fixed to an outer surface of a wheel on the inner surface of the tire.

The transition metal oxide is an oxide containing a transition metal. The transition metal oxide may be a composite oxide containing lithium and a transition metal, for example, a composite oxide containing lithium and titanium. Within a range of a potential of 1.0 V to 2.0 V with respect to lithium, such a composite oxide (for example, lithium titanate) has excellent reductive decomposition resistance to an electrolyte solution and an electrolyte, as compared with transition oxides such as an alloy-based oxide having a potential of less than 1 V, other silicon-based transition oxides, and tin-based transition oxides. Thus, the deterioration of the electrolyte such as a non-aqueous electrolyte solution and a solid electrolyte is small. In addition, since expansion and shrinkage during charging and discharging are small and the negative electrode itself hardly degrades, the composite oxide is particularly preferable. Examples of such a composite oxide will be described later.

### Tire

The tire according to the present exemplary embodiment is a tire to which device (D) according to the present exemplary embodiment is attached. The tire is not particularly limited, and may be a known tire. The tire may be a tire used for various transportation machines, or may be another tire. Examples of the transportation machine include an automobile (four-wheel vehicle, motor tricycle, motorcycle, and other automobile vehicles).

### Method for Attaching Flat Secondary Battery

An attachment method according to the present exemplary embodiment is a method for attaching a flat secondary battery used in a device including a substrate and attached to a tire. Hereinafter, the attachment method may be referred to as “attachment method (M)”. A multifunctional tire includes a tire and device (D) fixed to the tire. The multifunctional tire is produced by preparing device (D), preparing a tire, and fixing device (D) to the tire. The flat secondary battery is connected to the substrate with a terminal, and the flat secondary battery is further covered by a resin. The flat secondary battery includes an exterior body, and a positive electrode and a negative electrode disposed in the exterior body. The negative electrode contains a transition metal oxide as a negative electrode active material. The exterior body includes a positive electrode can having a bottomed cylindrical shape and a negative electrode can having a bottomed cylindrical shape. The negative electrode can faces the substrate. The negative electrode can is located between the positive electrode can and the substrate. The flat secondary battery is disposed outside the substrate as viewed from a rotation center of the tire. That is, the flat secondary battery is positioned farther from the rotation center than the substrate.

Attachment method (M) can be performed by attaching the flat secondary battery as described for device (D). Since the matters described for device (D) can be applied to attachment method (M), redundant description may be omitted. In attachment method (M), the effects described for device (D) can be obtained.

As described above, the transition metal oxide used as the negative electrode active material may be a composite oxide containing lithium and titanium.

Examples of the configuration and constituent elements of device (D) according to the present exemplary embodiment will be described below. However, the configuration and constituent elements of device (D) are not limited to the following description. As described above, the following description is also applicable to attachment method (M).

### Flat Secondary Battery

Examples of the flat secondary battery are batteries having a circular planar shape, and include coin-shaped and button-shaped secondary batteries. A lithium ion secondary battery containing a transition metal oxide as a negative electrode active material can be used as the flat secondary battery. The lithium ion secondary battery is not particularly limited, and a known lithium ion secondary battery may be used. A method for producing the flat secondary battery is not limited, and the flat secondary battery may be produced by a known method.

The flat secondary battery includes a positive electrode, a negative electrode, an electrolyte, and an exterior body. A separator may be disposed between the positive electrode and the negative electrode. Matters other than essential matters for the exemplary embodiment of the present disclosure are not particularly limited, and known configurations and constituent elements may be applied.

The positive electrode contains a positive electrode mixture, and the positive electrode mixture contains a positive electrode active material. A material in and from which lithium ions are occluded and released can be used as the positive electrode active material. Examples of the positive electrode active material include a composite oxide containing at least one selected from the group consisting of Ni, Co, Mn, Fe, and Al and lithium. The positive electrode active material includes, for example, lithium cobaltate, lithium nickelate, lithium manganate, a ternary nickel-manganese-lithium composite oxide, olivine type lithium iron phosphate, and lithium cobalt phosphate. The positive electrode mixture may contain various additives (e.g., binder and conductive material) in addition to the positive electrode active material. Alternatively, a positive electrode mixture containing only a positive electrode active material without various additives may be sintered and used as the positive electrode. The negative electrode contains a negative electrode mixture. The negative electrode mixture contains a negative electrode active material. The negative electrode mixture may contain various additives (e.g., binder and conductive material) in addition to the negative electrode active material. Alternatively, a negative electrode mixture containing only a negative electrode active material without various additives may be sintered and used as the negative electrode. Each of the positive electrode and the negative electrode may be formed in a columnar shape. In addition, in the primary battery using the lithium metal in the related art, there was also an influence of a distribution bias of the electrolyte solution due to the centrifugal force, however, if the positive electrode and the negative electrode formed in the columnar shape is used, such an influence is eliminated.

An oxide (for example, a transition metal oxide) in and from which lithium ions are occluded and released can be used as the negative electrode active material. The transition metal oxide contains at least a transition metal, and may contain an element other than the transition metal. Examples of the oxide (for example, transition metal oxide) of the negative electrode active material include SiO, SnO, CuO, Cu₂O, Fe₂O₃, Fe₃O₄, ZnO, PbO, MoO, MoO₂, TiO₂, Nb₂O₅, TiNb₂O₇, Li₄Ti₅O₁₂, Li₂TiO₃, and Li_{1.4}A_{10.4}Ti_{1.6}(PO₄)₃. Examples of the element that may be added to the oxide include at least one selected from the group consisting of Fe, Mn, Ni, Co, Sc, Y, Cu, Zn, Al, Cr, Pb, Sb, Mg, and B. Preferably, MoO, MoO₂, TiO₂, Nb₂O₅, TiNb₂O₇, Li₄Ti₅O₁₂, Li₂TiO₃, and Li_{1.4}A_{10.4}Ti_{11.6}(PO₄)₃, which have a potential of 1 V or more with respect to metal lithium and are less likely to cause reductive decomposition of the non-aqueous electrolyte solution or the solid electrolyte, are preferable. Further, a composite oxide containing lithium and titanium having very small expansion and shrinkage (i.e., volume change) during charging and discharging may be used. Examples of such a composite oxide include lithium titanate, and specifically include lithium titanate having an initial state which is represented by Li₄Ti₅O₁₂. A part of Ti may be substituted with different element from Ti, however, a content of the different elements is smaller than a content of Ti. Examples of the different element includes at least one selected from the group consisting of Fe, Mn, Ni, Co, Sc, Y, Cu, Zn, Al, Cr, Pb, Sb, Mg, and B.

A non-aqueous electrolyte solution in which a lithium salt is dissolved in a non-aqueous solvent, a solid electrolyte such as an inorganic solid electrolyte such as a sulfide-based, oxide-based, or chloride-based electrolyte containing lithium, or a polymer solid electrolyte containing a lithium salt, or an ionic liquid can be used as the electrolyte. It is preferable to use the solid electrolyte, since the influence of the distribution bias of the electrolyte solution due to the centrifugal force can be completely ignored. A nonwoven fabric or a microporous membrane may be used as the separator. The nonwoven fabric or the microporous membrane is made of an insulating material (for example, an insulating resin) such as an olefin-based material such as polypropylene or polyethylene, an engineering plastic material such as polyphenylene sulfide or polyether ether ketone, a cellulose-based material, or an inorganic material such as glass.

The exterior body includes a positive electrode can having a bottomed cylindrical shape and a negative electrode can having a bottomed cylindrical shape. The positive electrode can and the negative electrode can are disposed to face each other via a gasket to constitute a coin-shaped or button-shaped exterior body. The positive electrode is disposed on the positive electrode can, and the negative electrode is disposed on the negative electrode can. Materials of the positive electrode can, the negative electrode can, and the gasket are not particularly limited, and known materials used for the positive electrode can, the negative electrode can, and the gasket may be used. The material of the gasket is preferably a material that can withstand thermal curing during resin covering. Examples of the material of the gasket include engineering plastics such as polyphyllesulfide (PPS), polyetheretherketone (PEEK), and a copolymer of tetrafluoroethylene and perfluoroether (PFA), and olefin-based materials. In addition, a material obtained by adding glass or a filler to the above material can also be used.

As a material of the positive electrode can and a material of the negative electrode can, the following material can be used: iron or stainless steel; a clad material such as aluminum and iron, aluminum and stainless steel, iron and copper, and stainless steel and copper; and nickel-plated iron, nickel-plated stainless steel, and nickel-plated clad material. In addition, the material of the positive electrode can and the material of the negative electrode can may be each independently at least one selected from the group consisting of austenitic stainless steel, two-phase stainless steel including austenitic stainless steel and ferritic stainless steel, and nickel alloy. The material of the positive electrode can and the material of the negative electrode can may be the same as or different from each other. These materials have weaker magnetism than other materials. In a case where the secondary battery is charged by wireless power supply using electromagnetic induction such as magnetic field resonance or magnetic field coupling, an exterior can (a positive electrode can and a negative electrode can) made of a material having weak magnetism is used, and thus, the exterior can is prevented from being heated by a magnetic flux supplied for wireless power supply. As a result, it is possible to suppress the degradation of the flat secondary battery due to a temperature rise in heating.

The positive electrode can can function as a positive-electrode terminal, and the negative electrode can function as a negative-electrode terminal. A conductive layer (e.g., carbon layer or current collector) may be disposed between the positive electrode mixture and the positive electrode can. A conductive layer (e.g., carbon layer or current collector) may be disposed between the negative electrode mixture and the negative electrode can.

The negative electrode can is disposed to face the substrate. A bottom surface of the negative electrode can is usually disposed to be substantially parallel to the substrate, but may be inclined to some extent (for example, at an angle of 30° or less) from a state of being substantially parallel to the substrate.

### Substrate

The substrate is not particularly limited, as long as the substrate can stably hold the flat secondary battery. A known substrate may be used as the substrate. Examples of the substrate include a known substrate used as a printed board. Examples of the material of the substrate include paper, resin such as epoxy, glass, and ceramics. The substrate may be made of at least one of these materials. The substrate includes an electric wiring.

A size of the substrate is not particularly limited, but is usually larger than the planar shape of the flat secondary battery. From the viewpoint of the influence on the balance of the tire, the substrate having the smaller size is preferable. For example, in a case where the planar shape of the substrate is a rectangular shape, a length of a side may be in a range of 1 to 2 times (for example, a range of 1.1 to 1.8 times) diameter D of a circular shape of the planar shape of the flat secondary battery. An area of the planar shape of the substrate may be in a range of 1 to 2 times (for example, a range of 1.1 to 1.8 times) an area of the planar shape of the flat secondary battery.

### Resin

A resin for covering the flat secondary battery is not particularly limited. In PTL 2, a material that ensures water resistance and moisture resistance is used, but in the present invention, a material having high impact absorbability such as high vibration absorbability is preferably used. A resin used for sealing the electronic component may be used as the resin. Examples of the resin include a urethane resin, an epoxy resin, and a silicone resin. The resin may contain a filler such as inorganic particles.

The resin is disposed to cover at least a substrate and a flat secondary battery having a terminal. In this configuration, it is possible to suppress disconnection between the flat secondary battery terminal and the substrate. In addition, it is possible to suppress the influence of the physical external force directly on the battery. In a case where device (D) includes a housing surrounding the flat secondary battery, an inside of the housing may be filled with the resin.

### Electronic Component Other Than Flat Secondary Battery

In accordance with the purpose thereof, device (D) may include a sensor, a power receiver, a power generating element, a transmitter, and a processor, as the electronic components other than the flat secondary battery. Power is supplied from the flat secondary battery to these electronic components as necessary.

Examples of the sensor include pressure sensors, acceleration sensors and temperature sensors. The transmitter is an element for transmitting various types of information (for example, information obtained by the sensor) to a receiver, and includes an antenna. The processor performs various types of processing and control. For example, the processor transmits information output from the sensor via the antenna. An integrated circuit (IC) may be used as the processor.

The information transmitted from the transmitter is received by, for example, a receiver disposed in a vehicle body. The received information is processed and used by, for example, a control device disposed in a vehicle body.

The flat secondary battery of device (D) may be charged by wireless power supply. For example, the flat secondary battery of device (D) may be charged by wireless power supply using electromagnetic induction such as magnetic field resonance or magnetic field coupling. In such a case, a power transmitter (e.g., coil, antenna) for wireless power supply is disposed in a vehicle body, and device (D) includes a power receiver. The power receiver is a portion that generates power by electromagnetic induction. Examples of the power receiver include a coil and an antenna. The flat secondary battery of device (D) may be charged by a power generating element. Examples of the power generating element include a piezoelectric element that generates power by using vibration and a Peltier element that generates power by using a temperature difference. The secondary battery may be charged in a substantially continuous way. Alternatively, the secondary battery may be discharged in some degree, and then, the secondary battery may be charged (charge and discharge cycle). For example, the secondary battery may be charged when the secondary battery is discharged at a capacity of 1%, the secondary battery may be charged when the secondary battery is discharged at a capacity of 50%, and the secondary battery may be charged when the secondary battery is discharged at a capacity of 100%. In particular, as the temperature becomes higher, for example, 85° C., 105° C., or 125° C. in a state close to full charging, the reaction between the negative electrode and the electrolyte proceeds, and thus, the capacity decreases due to an increase in resistance of the battery. In the negative electrode using the lithium alloy of PTL 3 as the active material, the charging and discharging cycle is repeated, and thus, the pulverization proceeds due to the expansion and shrinkage of the active material. As a result, the reaction area increases, and thus, charging degradation at a high temperature further proceeds. In addition, since the pulverization occurs due to the physical force from the outside of the tire, characteristic deterioration of the battery is further accelerated due to a decrease in capacity or a decrease in current collectability due to the desorption of the active material.

### Terminal

One end of a terminal (i.e., lead terminal) can be connected to each of the positive electrode can and the negative electrode can. The other end of the terminal may be connected to the wiring of the substrate. The shape of the terminal is not particularly limited, as long as the terminal can be electrically connected. For example, a terminal made of metal such as stainless steel can be used as the terminal. In the case of the wireless power supply using electromagnetic induction such as magnetic field resonance or magnetic field coupling, a material having particularly weak magnetism is preferable. The material may be at least one selected independently from the group consisting of austenitic stainless steel, two-phase stainless steel including austenitic stainless steel and ferritic stainless steel, and nickel alloy. The materials of the positive electrode can and the negative electrode can may be the same or different from each other. The terminal is connected to the exterior can of the flat secondary battery by, for example, resistance welding or laser welding. In addition, the terminal are connected to the substrate with solder for electrical connection between the substrate and the terminal, for example,.

### Housing

Device (D) may include a housing surrounding the flat secondary battery. The housing may surround entire device (D). However, in a case where the flat secondary battery is charged by wireless power supply, the housing is selected such that wireless power supply is allowed. The housing is not particularly limited, and a housing made of metal and/or resin may be used.

Hereinafter, an example of the exemplary embodiment according to the present disclosure will be specifically described with reference to the drawings. Exemplary embodiments to be described below can be modified on the basis of the above description. In addition, the matters to be described below may be applied to the exemplary embodiment described above. In addition, the exemplary embodiments to be described below, matters that are not essential to the invention of the present disclosure may be omitted.

### First Exemplary Embodiment

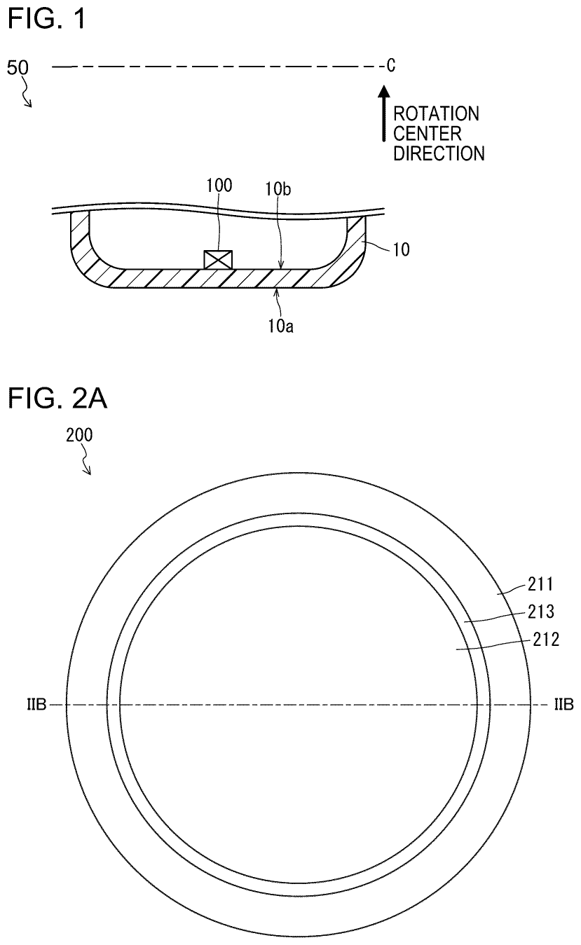

In a first exemplary embodiment, examples of device (D), a tire to which the device is attached, and attachment method (M) will be described. FIG. 1 illustrates a sectional view of a portion of tire 10 to which device 100 is attached. Multifunctional tire 50 includes tire 10 and device 100 fixed to tire 10.

The sectional view of FIG. 1 illustrates a section of a part of tire 10 in a plane including rotation center C of tire 10 (i.e., in a plane illustrated in FIG. 1). Tire 10 is a rubber tire used for an automobile, and is configured to rotate about rotation center C. Device 100 is device (D) described above. Device 100 is attached to inner surface 10b on a surface (i.e., an inner surface) opposite to a ground contact surface (i.e., an outer surface) 10a of a tread portion of tire 10. Device 100 is fixed to inner surface 10b with an adhesive.

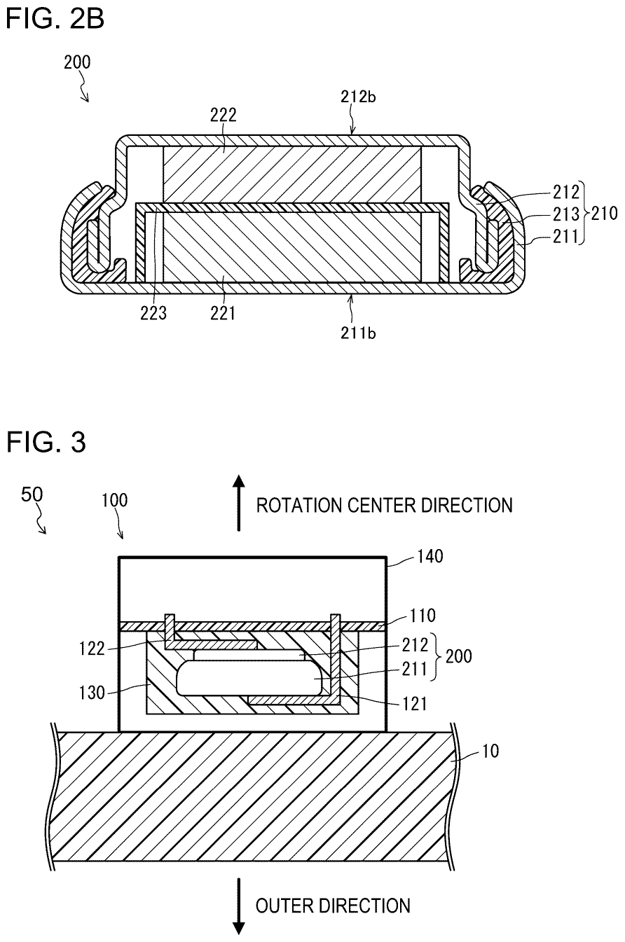

Device 100 includes flat secondary battery 200. A top view of secondary battery 200 is illustrated in FIG. 2A, and a sectional view taken along line IIB-IIB in FIG. 2A is illustrated in FIG. 2B. As illustrated in FIGS. 2A and 2B, secondary battery 200 has a coin shape (i.e., a low columnar shape).

Secondary battery 200 includes exterior body 210, positive electrode 221, negative electrode 222, separator 223, and a non-aqueous electrolyte. Exterior body 210 includes positive electrode can 211 having a bottomed cylindrical shape, negative electrode can 212 having a bottomed cylindrical shape, and gasket 213. Coin-shaped exterior body 210 is formed by setting positive electrode can 211 and negative electrode can 212 to face each other via a gasket.

Positive electrode can 211 includes bottom surface 211b having a circular shape and a portion having a cylindrical shape rising from an outer edge portion of bottom surface 211b. Negative electrode can 212 includes circular bottom surface 212b and a portion having a cylindrical shape rising from an outer edge portion of bottom surface 212b. In the example illustrated in FIG. 2B, at least a part of the cylindrical portion of negative electrode can 212 is disposed inside the cylindrical portion of positive electrode can 211. Positive electrode can 211 and negative electrode can 212 are made of SUS316L of austenitic stainless steel.

Positive electrode 221 and negative electrode 222 are each formed by molding a positive electrode mixture and a negative electrode mixture into a cylindrical shape. Thereafter, drying is performed at a high temperature of 100° C. or higher. The positive electrode mixture contains lithium cobalt oxide as an active material, acetylene black as a conductive agent, and a fluorine-based resin as a binder. The negative electrode mixture is made of lithium titanate as an active material, acetylene black as a conductive agent, and a rubber-based material as a binder. A battery voltage in a charged state is 2.6 V. A potential of the positive electrode at a room temperature is about 4.0 V with respect to metal lithium. A potential of the negative electrode at room temperature is about 1.4 V with respect to metal lithium. Positive electrode 221 is disposed on positive electrode can 211, and abuts on positive electrode can 211 to face the positive electrode can 211. Negative electrode 222 is disposed on negative electrode can 212 and abuts on negative electrode can 212 to face the negative electrode can 212. Separator 223 is disposed between positive electrode 221 and negative electrode 222. Separator 223, positive electrode 221, and negative electrode 222 are filled with a non-aqueous electrolyte solution.

FIG. 3 schematically illustrates a configuration of device 100. In FIG. 3, hatching is partially omitted for easy viewing of the drawing. Referring to FIG. 3, device 100 includes substrate 110, resin 130, housing 140, and flat secondary battery 200 connected to substrate 110 with terminals (i.e., lead terminals) 121 and 122.

Secondary battery 200 is soldered to an electric wiring of substrate 110 with terminal 121 connected to positive electrode can 211 and terminal 122 connected to negative electrode can 212. Resin 130 is disposed to surround secondary battery 200 and terminals 121 and 122. Resin 130 is disposed between substrate 110 and secondary battery 200. Resin 130 fixes secondary battery 200 to substrate 110 by embedding secondary battery 200 in resin 130. Housing 140 surrounds secondary battery 200 and functions as an exterior body of device 100.

Secondary battery 200 is disposed outside substrate 110 as viewed from rotation center C of tire 10. That is, secondary battery 200 is disposed farther from rotation center C of tire 10 than substrate 110. Secondary battery 200 is disposed such that negative electrode can 212 faces substrate 110. Negative electrode can 212 is located between positive electrode can 211 and substrate 110. That is, a bottom surface of negative electrode can 212 is disposed closer to the rotation center, that is, closer to rotation center C, than a bottom surface of positive electrode can 211. That is, the negative electrode is disposed closer to the rotation center, that is, closer to rotation center C, than the positive electrode. In the configuration of the first exemplary embodiment, the above-described effects can be obtained.

In addition to a centrifugal force, device 100 is strongly influenced by the vibration or impact from the road surface or the temperature change from the low temperature to the high temperature. In a case where secondary battery 200 with a terminal is not embedded in resin 130, connection between terminals 121 and 122 of secondary battery 200 and the substrate is easily disconnected due to the vibration or impact from the road surface. In addition, in a case where secondary battery 200 is disposed such that positive electrode can 211 faces substrate 110, an increase in resistance due to a reaction (at the time of high temperature charging) between the negative electrode and the electrolyte, the reaction between the negative electrode and the electrolyte is susceptible to an increase in temperature, increases. Thus, the progress of degradation of the secondary battery is accelerated. In addition, the negative electrode is easily influenced by the physical force such as an external impact. Thus, the degradation of the secondary battery is accelerated. This is remarkable in a case where a lithium alloy negative electrode is used as the negative electrode active material. In addition, in the example of the related art, the disposition of an expansion part of the battery and the resin embedding are taken to suppress the separation of the battery from the substrate due to the expansion of the battery at a high temperature, but a problem derived from the charging and discharging of the secondary battery is not considered. On the other hand, in device 100 according to the present disclosure, the occurrence of these problems can be suppressed.

### Appendix

The following technologies are disclosed by the above description.

### Technology 1

A multifunctional tire comprising:
a tire configured to rotate about a rotation center; and
a device fixed to the tire,
wherein the device includes a substrate and a flat secondary battery connected to the substrate via a terminal, and the flat secondary battery is covered by a resin,
the flat secondary battery includes an exterior body, and a positive electrode and a negative electrode disposed in the exterior body,
the negative electrode contains a transition metal oxide as a negative electrode active material,
the exterior body includes a positive electrode can having a bottomed cylindrical shape and a negative electrode can having a bottomed cylindrical shape,
the negative electrode can faces the substrate, and
the flat secondary battery is disposed outside the substrate as viewed from the rotation center of the tire.

### Technology 2

The multifunctional tire according to Technology 1, wherein the transition metal oxide is a composite oxide containing lithium and titanium.

### Technology 3

The multifunctional tire according to Technology 1 or 2, wherein the negative electrode can is located between the positive electrode can and the substrate.

### Technology 4

A method for producing a multifunctional tire, comprising:
preparing a device including a substrate and a flat secondary battery;
preparing a tire configured to rotate about a rotation center; and
fixing the device to the tire,
wherein the flat secondary battery is connected to the substrate via a terminal, and the flat secondary battery is covered by a resin,
the flat secondary battery includes an exterior body, and a positive electrode and a negative electrode disposed in the exterior body,
the negative electrode contains a transition metal oxide as a negative electrode active material,
the exterior body includes a positive electrode can having a bottomed cylindrical shape and a negative electrode can having a bottomed cylindrical shape,
the negative electrode can faces the substrate, and
the fixing of the device to the tire includes fixing the device to the tire to allow the flat secondary battery to be disposed outside the substrate as viewed from the rotation center of the tire.

### Technology 5

The method according to Technology 4, wherein the transition metal oxide is a composite oxide containing lithium and titanium.

### Technology 6

The method according to Technology 4 or 5, wherein the negative electrode can is located between the positive electrode can and the substrate.

### INDUSTRIAL APPLICABILITY

The present disclosure can be used for a multifunctional tire including a tire and a device attached to the tire, and a method for producing a multifunctional tire.

### REFERENCE MARKS IN THE DRAWINGS

10 tire
10a ground contact surface
50 multifunctional tire
100 device
110 substrate
121, 122 terminal
130 resin
140 housing
200 flat secondary battery
210 exterior body
211 positive electrode can
212 negative electrode can
213 gasket
221 positive electrode
222 negative electrode
223 separator
C rotation center

1. A multifunctional tire comprising:
a tire configured to rotate about a rotation center; and
a device fixed to the tire,
wherein the device includes a substrate and a flat secondary battery connected to the substrate via a terminal, and the flat secondary battery is covered by a resin,
the flat secondary battery includes an exterior body, and a positive electrode and a negative electrode disposed in the exterior body,
the negative electrode contains a transition metal oxide as a negative electrode active material,
the exterior body includes a positive electrode can having a bottomed cylindrical shape and a negative electrode can having a bottomed cylindrical shape,
the negative electrode can faces the substrate, and
the flat secondary battery is disposed outside the substrate as viewed from the rotation center of the tire.

2. The multifunctional tire according to claim 1, wherein the transition metal oxide is a composite oxide containing lithium and titanium.

3. The multifunctional tire according to claim 1, wherein the negative electrode can is located between the positive electrode can and the substrate.

4. A method for producing a multifunctional tire, comprising:
preparing a device including a substrate and a flat secondary battery;
preparing a tire configured to rotate about a rotation center; and
fixing the device to the tire,
wherein the flat secondary battery is connected to the substrate via a terminal, and the flat secondary battery is covered by a resin,
the flat secondary battery includes an exterior body, and a positive electrode and a negative electrode disposed in the exterior body,
the negative electrode contains a transition metal oxide as a negative electrode active material,
the exterior body includes a positive electrode can having a bottomed cylindrical shape and a negative electrode can having a bottomed cylindrical shape,
the negative electrode can faces the substrate, and
the fixing of the device to the tire includes fixing the device to the tire to allow the flat secondary battery to be disposed outside the substrate as viewed from the rotation center of the tire

5. The method according to claim 4, wherein the transition metal oxide is a composite oxide containing lithium and titanium.

6. The method according to claim 4, wherein the negative electrode can is located between the positive electrode can and the substrate.
